(19) United States
(12) Patent Application Publication
(10) Pub. No.: US 2013/0107501 A1
(43) Pub. Date: May 2, 2013

(54) Suspension Device For Presenting Goods, Having A Profile Rail And A Primary Support That Can Be Hung Therein

(71) Applicants: Andreas Ewald, Kandern (DE); Herbert Walter, Mullheim (DE)

(72) Inventors: Andreas Ewald, Kandern (DE); Herbert Walter, Mullheim (DE)

(73) Assignee: VISPLAY INTERNATIONAL AG, Muttenz (CH)

(21) Appl. No.: 13/809,596

(22) PCT Filed: Jul. 21, 2011
(86) PCT No.: PCT/CH2011/000168

§ 371 Date: Jan. 11, 2013

(30) Foreign Application Priority Data
Jul. 21, 2010 (DE) 20 2010 010 444.0

(51) Int. Cl. F21S 8/00

(52) U.S. Cl. CPC F21S 8/00
USPC 362/145

(57) ABSTRACT

The suspension device for presenting goods comprises a profile rail (1), into which an electrical profiled element (2) is inserted, through which electrical conductors (21) partially embedded in insulation (20) extend. The electrical conductors are accessible via a passage (10) of the profile rail (1) that opens to the outside. A primary support (4) that can be hung in the profile rail (1) has an insertion section (416,426) that can be inserted into the passage (10). An adapter (5) is arranged on the insertion section (416) of the primary support (4). Said adapter is designed to tap current on the electrical conductors (21) in order to operate a lighting unit (7). An electrical supply line (6) extends from the adapter (5) to the lighting unit (7). The adapter (5) has a housing (52) and a current collector (54) having contacts (541), which are intended to tap current on the electrical conductors (21). The contacts (541) protrude from the housing (52) in a spring-loaded manner and can be pushed back into the housing (52) when the insertion section (416) is inserted into the passage (10). The contacts (541) are pressed against the electrical conductors (21) by the spring force when the insertion section (416) is completely inserted into the passage (10) and the contacts are positioned congruently to the electrical conductors (21).

### FIELD OF APPLICATION OF THE INVENTION

The present invention relates to a suspension device for presenting goods, having a profile rail into which an electrical profile is inserted through which extend electrical conductors that are partially embedded in insulation and can be accessed via a passage of the profile rail that opens to the outside. Also part of the suspension device is a primary support that can be hung in the profile rail and has an insertion section that can be pushed into the passage. An adapter, that is designed to take off current at the electrical conductors to operate a lighting unit, can be arranged on the insertion section of the primary support. An electrical supply line extends from the adapter to the lighting unit. The adapter has a housing and current collectors with contacts that are designed to tap current at the electrical conductors.

### PRIOR ART

A suspension device having a profile rail that is arranged horizontally and primary supports that can be hung therein is known from WO 01/43599 A1. As a development of the abovementioned suspension device, the device according to

WO 03/070060 A1 was provided in which an electrical profile is inserted and hence allows current to be tapped via an adapter to operate a consumer, in particular a lamp. Primary supports in the form of trays having an adapter fastened thereto, or non-electrified support arms, can be inserted into the profile rail of the abovementioned invention.

The suspension device for presenting goods disclosed in DE 20 2008 003 360 U1 consists of a profile rail into which an electrical profile is inserted. Electrical conductors that are partially embedded in insulation and can be accessed via a passage of the profile rail that opens to the outside extend through the electrical profile. A primary support that can be hung in the profile rail has an insertion section that can be pushed into the passage. An adapter, that is designed to tap current at the electrical conductors to operate a lighting unit, can be arranged on the insertion section of the primary support. An electrical supply line extends from the adapter to the lighting unit. The adapter positioned on the insertion section has a housing for receiving the current collectors with contacts that protrude from the housing when the adapter is activated and touch the electrical conductors. The adapter has an actuator that, when the insertion section is pushed into the passage, moves the contacts of the current collectors of the adapter toward the electrical conductors of the electrical profile as a result of the impact inside the profile rail.

### OBJECT OF THE INVENTION

The object of the invention is to further simplify the handling with electrified primary supports when they are inserted into the profile rail and in particular when current is tapped by the adapter, and thus to propose a different solution from what is known from the prior art. A second object is to expand the range of possible designs of the suspension device and its scope of application. The esthetic requirements for installation in retail outlets need to be taken into consideration hereby. Moreover, it is intended that the device can be produced and fitted so that the requirements of specific customers can be met at a viable cost.

### SUMMARY OF THE INVENTION

The suspension device for presenting goods consists of a profile rail into which an electrical profile is inserted through which extend electrical conductors that are partially embedded in insulation and can be accessed via a passage of the profile rail that opens to the outside. A primary support that can be hung in the profile rail has an insertion section that can be pushed into the passage. An adapter, that is designed to tap current at the electrical conductors to operate a lighting unit is arranged on the insertion section of the primary support. An electrical supply line extends from the adapter to the lighting unit. The adapter has a housing and current collectors with contacts that are designed to tap current at the electrical conductors. The spring-loaded contacts protrude from the housing and can be pushed back into the housing when the insertion section is pushed into the passage. When the insertion section has been pushed completely into the passage and positioned congruently with the electrical conductors, the contacts are pressed against the electrical conductors by the spring force.

Specific embodiments of the invention are defined below: the spring loading of the current collectors is based on their inherent elasticity with a degree of bending travel.

The adapter has a rear part and a front section designed to be inserted into the passage of the profile rail and in which the contacts are arranged. The adapter has two current collectors that are each formed from a wire mounted so that it can move elastically in the housing. The contact of a current collector is situated at its front free end and is formed from a hook that tapers upwards and is, for example, V-shaped or U-shaped. The bending section extends from the contact as far as a terminal region that represents the rear end of the current collector. A connector is present at the terminal region that leads to the electrical supply line. The housing has recesses inside which the current collectors are received in such a way that they can move vertically elastically.

The housing consists of a bottom part and a top part. An indentation that opens in the direction of the recesses and the top part is in each case present in the rear part of the bottom part and is flush with the recesses that extend lengthwise, so that the terminal region of a current collector can be housed therein. Mutually complementary first locking members and second locking members are provided in the top part and the bottom part in order to connect the two together, at least one pair of the locking members that engage with each other additionally being secured by means of screws. When the housing is assembled, the adapter has, in its rear part adjacent to the inserted terminal regions of the current collectors, an opening that opens to the outside for connection to the primary support. The bottom part has a relieved portion that widens the opening and serves to lead the supply line to the connectors of the current collectors.

A connection region of the primary support in the form of a tray is fixed in the opening of the adapter. The tray has the insertion section that is designed to be pushed with its rear edge at the front into the outwardly open passage of the profile rail. A cutout is provided in the insertion section, is open at the rear edge, adjoins the connection region, and inside which the front section of the adapter is arranged.

The tray has a top side, an underside, and a front edge that faces the room. The lighting unit is preferably arranged on the top side and/or underside and/or front edge.

Alternatively, the tray has a top side, an underside, and a front edge that faces the room, an attached downwardly inclined add-on section extending from the latter. The lighting unit is preferably arranged on the underside of the add-on section. The tray and the add-on section can be made from different materials.

In another alternative, the tray merges, with respect to the insertion section, integrally into a downwardly inclined add-on section that faces the room. The lighting unit is in turn preferably arranged on the underside of the add-on section. In this embodiment, the tray and the add-on section are preferably made from the same material.

The profile rail has:
a) a bottom bar adjoining the passage on one side and inside which, facing the entrance into the passage, a bottom groove is situated for receiving a profile strip to prevent slipping and as a damping element for the inserted primary support;
b) a top bar adjoining the passage on the other side and inside which are situated:
ba) facing the entrance into the passage, a top groove for receiving the electrical profile; and
bb) in the rear region of the passage, a hook groove that serves for the engagement of a complementary hook on the insertion section of the primary support in the form of a support arm; and
c) a flat base into which the bottom bar and the top bar open and which defines the end of the passage.

The profile rail also has:
a) a support bar that extends from the bottom bar at an angle toward the base;
b) a support bar that extends from the top bar at an angle toward the base;
c) retaining contours on the bottom groove and retaining contours on the top groove for fixing the inserted profile strip and the inserted electrical profile;
d) a lip as a continuation of the bottom bar and a lip as a continuation of the top bar to form the entrance into the passage;
e) a rail that starts from the bottom bar and has an adjoining external groove and a rail that starts from the top bar and has an adjoining external groove, which are used to add panel elements by their longitudinal edges in an interlocking fashion;
f) in each case an extension that extends downward and upward flush from the base and projects beyond the respective support bar that is open there;
g) a lower cavity that is formed between the bottom bar, the lower support bar, and the base;
h) an upper cavity that is formed between the top bar, the upper support bar, and the base; and
i) in each case an axially extending screw channel that adjoins the cavities.

A power feed unit is provided that has:
a) a housing with an end face from which a profile piece extends;
b) electrical connectors that lie embedded in grooves present on the profile piece and each have a contact face;
c) a spring beneath each electrical connector in the associated groove;
d) contours on the profile piece that are designed to engage in a complementary fashion with the electrical profile inserted in the profile rail and the contours present thereon; and
e) a cavity in which the connectors are received and which is continued by a cable leading to the power source; wherein
f) when the power feed unit is connected to the profile rail, the contact faces of the connectors bear against the electrical conductors of the electrical profile and the springs that are thus slightly tensioned ensure that current is tapped securely and permanently.

The electrical conductors preferably conduct low voltage. The lighting unit is fitted with LEDs.

The primary support has the form of a support arm and has:
a) the insertion section facing the profile rail;
b) a rod part that projects into the room and the first end of which is connected to the insertion section and which has a free second end;
c) a cutout in the insertion section that is open toward the free end of the insertion section and is designed for the insertion of the adapter; and
d) a lighting unit arranged on the rod part.

### BRIEF DESCRIPTION OF THE ATTACHED DRAWINGS

In the drawings:

FIG. 1—shows a perspective view of a wall structure having multiple profile rails and panel elements added in between them, fitted with different primary supports and a single adapter;

FIG. 2A—shows a perspective view from below of a primary support from FIG. 1A in the form of a tray, with an adapter, the supply line, the retaining device, and the lighting unit;

FIG. 2B—shows a perspective plan view of the primary support according to FIG. 2A;

FIG. 2C—shows a perspective plan view of the primary support according to FIG. 2A with a modified retaining device and lighting unit;

FIG. 2D—shows the enlarged detail X1 from FIG. 2C;

FIG. 3A—shows a perspective view of a primary support from FIG. 1 in the form of a support arm;

FIG. 3B—shows the enlarged detail X2 from FIG. 3A, in a vertical section;

FIG. 4A—shows a profile rail from FIG. 1 in cross section;

FIG. 4B—shows a perspective view of the profile rail according to FIG. 4A;

FIG. 5A—shows an electrical profile in cross section;

FIG. 5B—shows a perspective view of the electrical profile according to FIG. 5A;

FIG. 6A—shows a profile strip in cross section;

FIG. 6B—shows a perspective view of the profile strip according to FIG. 6A;

FIG. 7A—shows the profile rail according to FIG. 4A with an inserted electrical profile according to FIG. 5A and a profile strip according to FIG. 6A in cross section;

FIG. 7B—shows a perspective view of the arrangement according to FIG. 7A;

FIG. 8A—shows a side view of an adapter from FIG. 1;

FIG. 8B—shows a perspective plan view of an adapter according to FIG. 8A;

FIG. 8C—shows a perspective view from below of an adapter according to FIG. 8A;

FIG. 9A—shows a perspective exploded view from above of the adapter according to FIG. 8A;

FIG. 9B—shows a modified perspective exploded view from above of the adapter according to FIG. 9A;

FIG. 9C—shows a perspective exploded view from below of the adapter according to FIG. 9A;

FIG. 9D—shows a perspective exploded view of the adapter according to FIG. 9A, with current collectors inserted into the base;

FIG. 9E—shows the adapter according to FIG. 8A in vertical section;

FIG. 10A—shows a first perspective view of a power feed unit with a housing, profile piece, connectors, and a cover;

FIG. 10B—shows a second perspective view of the power feed unit according to FIG. 10A;

FIG. 10C—shows a third perspective view of the power feed unit according to FIG. 10A;

FIG. 10D—shows a fourth perspective view of the power feed unit according to FIG. 10A;

FIG. 10E—shows the power feed unit according to FIG. 10A in vertical section;

FIG. 10F—shows a perspective exploded view of the power feed unit according to FIG. 10C;

FIG. 10G—shows a modified perspective exploded view of the power feed unit according to FIG. 10F;

FIG. 11A—shows a perspective view of the power feed unit according to FIG. 10A, placed close to the profile rail according to FIG. 7A, without a profile strip;

FIG. 11B—shows a modified perspective view of the arrangement according to FIG. 11A;

FIG. 11C—shows a perspective view of the arrangement according to FIG. 11A, with the power feed unit docked to the profile rail;

FIG. 11D—shows a modified perspective view of the arrangement according to FIG. 11C;

FIG. 11E—shows a further modified perspective view of the arrangement according to FIG. 11C;

FIG. 12A—shows a perspective view from above of the tray according to FIG. 2B, with separated adapter parts placed close to the cutout;

FIG. 12B—shows a perspective view from below of the arrangement according to FIG. 12A;

FIGS. 13A to 13C show the process of inserting a tray according to FIG. 2B into a profile rail in three stages, as schematic diagrams in vertical section;

FIG. 13A—shows the initial stage where the tray, with its insertion section and adapter, brought close to a profile rail mounted on a support structure and inserted into panel elements;

FIG. 13B—shows the intermediate stage of the arrangement according to FIG. 13A, with the adapter and insertion section of the tray partially inserted into the profile rail;

FIG. 13C—shows the final stage of the arrangement according to FIG. 13A, where the adapter and insertion section of the tray are inserted into the profile rail in the intended final position;

FIG. 14—shows the support arm according to FIG. 3A inserted into the profile rail in the intended final position, in vertical section;

FIG. 15A—shows a perspective view from below of a primary support according to FIG. 2A with an attached added section, a modified retaining device, and a lighting unit;

FIG. 15B—shows a perspective plan view of the primary support according to FIG. 15A;

FIG. 15C—shows a perspective exploded view from above of the tray according to FIG. 15B, with separated adapter parts placed close to the cutout, an added section detached from the tray, a supply line, and a lighting unit;

FIG. 15D—shows the enlarged detail X3 from FIG. 15A;

FIG. 15E—shows a vertical section through the arrangement according to FIG. 15D;

FIG. 16A—shows a perspective view from below of a primary support according to FIG. 2A with a bent added section, a modified retaining device, and a lighting unit;

FIG. 16B—shows a perspective plan view of the primary support according to FIG. 16A;

FIG. 16C—shows a perspective exploded view from above of the tray according to FIG. 16B, with separated adapter parts placed close to the cutout, a supply line detached from the tray, and a lighting unit; and

FIG. 16D—shows the enlarged detail X4 from FIG. 16C.

### EXEMPLARY EMBODIMENT

A detailed description follows, with reference to the attached drawings, of an exemplary embodiment of the suspension device for presenting goods according to the invention, with the primary supports that can be inserted in alternative fashions.

The following statement applies to the whole of the rest of the description. If reference numerals are included in a drawing to make it clearer but are not explained in the directly relevant text of the description, reference should be made to where they are mentioned in the preceding or subsequent descriptions of the drawings. For the sake of clarity, components are usually not numbered again in later drawings, as long as it can be clearly seen in the drawings that these are “recurring” components.

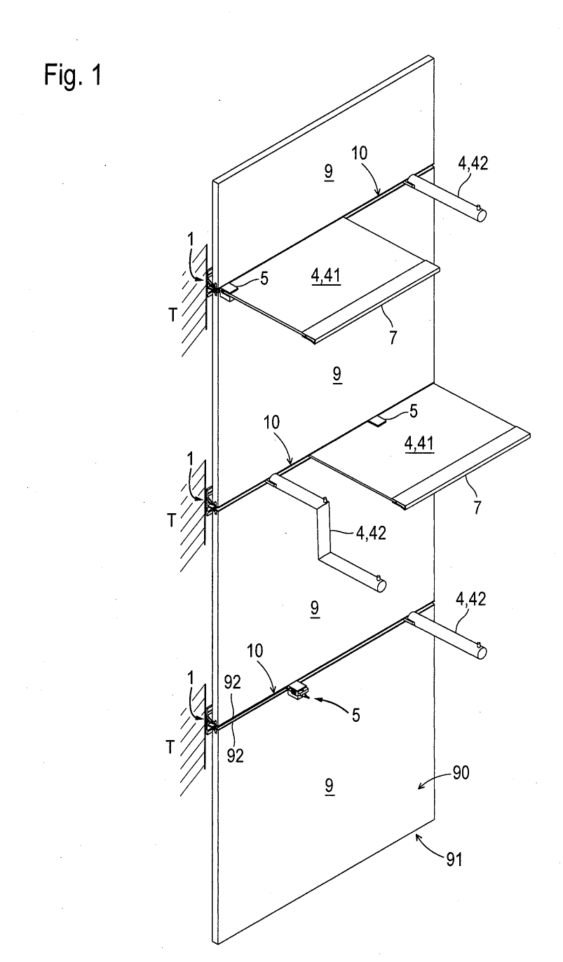

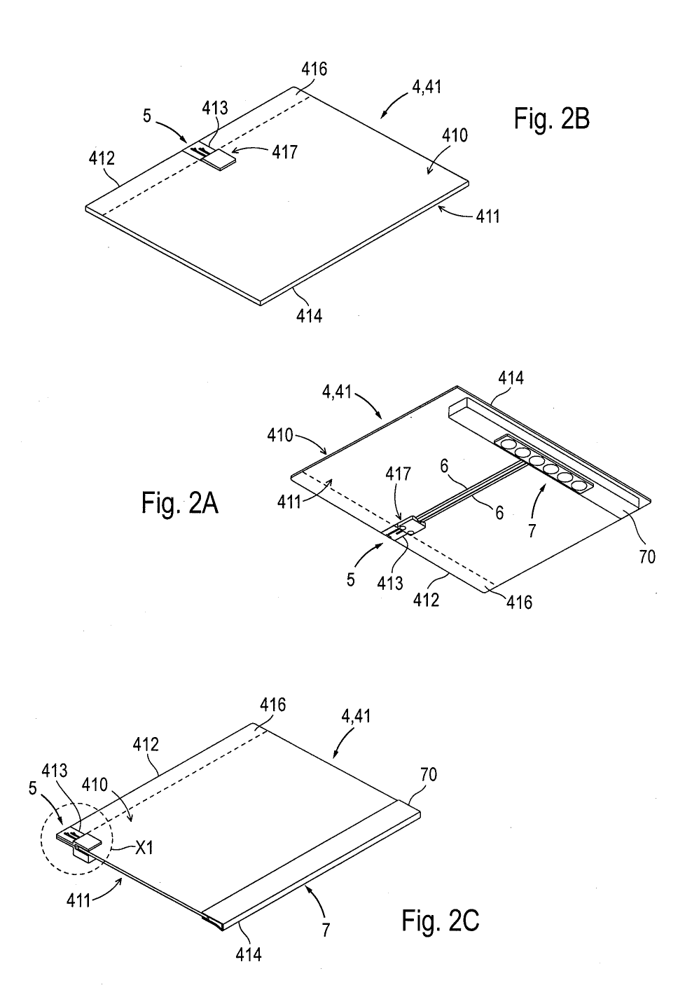

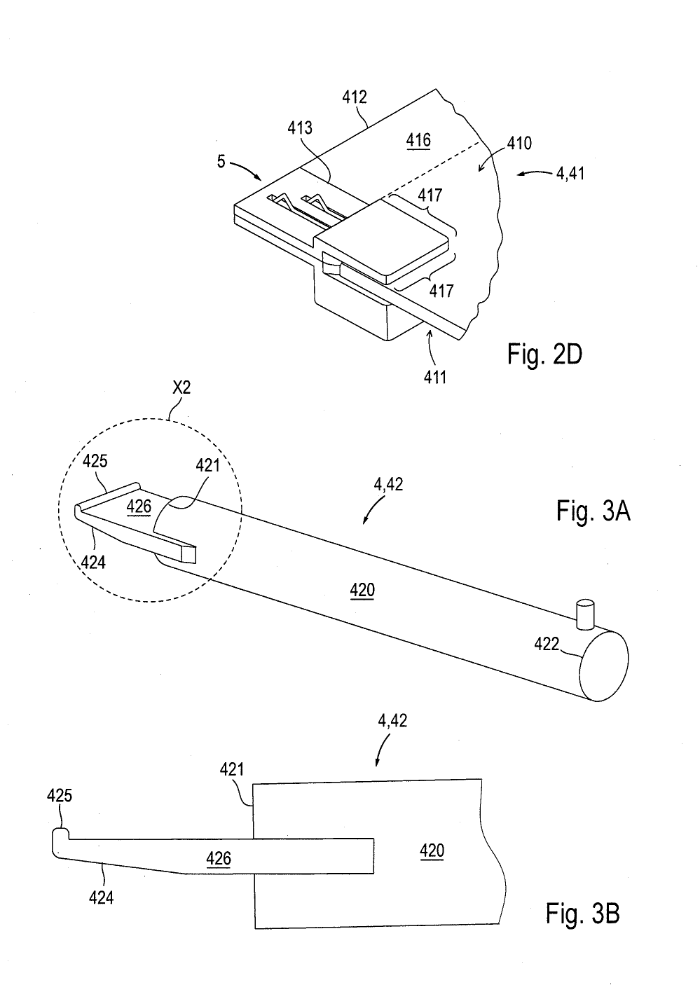

FIGS. 1 to 2D

The profile rail 1 is designed to be mounted horizontally on a support structure T, wherein a panel element 9 can then be placed in vertical alignment on the profile rail 1. To allow this, a corresponding longitudinal edge 92 runs along the panel element 9, thereby enabling the profile rail 1 to be pushed on to connect it. The panel element 9 has a front side 90 and a rear side 91, the rear side 91 facing the support structure T. The profile rail 1 has a passage 10, running over the entire length and facing the user, into which primary supports 4 in the form of trays 41 and support arms 42 can be inserted.

The rectangular tray 41 has a top side 410, an underside 411, and a rear edge 412 opposite the front edge 414 and in which a cutout 413 is made. A strip-like insertion section 416 extends from the rear edge 412 into the tray 41 and is designed to be pushed into the passage 10 of the profile rail 1. The cutout 413 is adjoined by a connection region 417 that serves to fasten an adapter 5 and from which a supply line 6 extends, along the underside 411 or the top side 410, as far as a lighting unit 7. The lighting unit 7 can take the form of a point light source or a linear luminaire and has a retaining device 70, for example in the form of a housing. The cutout 413 in the insertion section 416, and the connection region 417 situated behind it for receiving the adapter 5, can be provided at any point along the insertion section 416, for example centrally according to FIG. 2A or on the outside according to FIG. 2C.

FIGS. 3A and 3B

The support arm 42 essentially consists of a rod part 420 that extends between the first end 421 and the second end 422. A flat insertion section 426 is arranged at the first end 421. A hook 425 projects upward from the free end of the insertion section 426. The insertion section 426 has on its underside a tapered shape running toward the hook 425 and from the transition point to the rod part 420.

In an alternative embodiment not shown here, a cutout is present on the insertion section 426 and is open toward the free end of the insertion section 426. The connection region 417 equivalent to the tray 41 extends at the support arm 42 into the first end 421 of the rod part 420. The cutout and connection region are designed for the insertion of the adapter 5. A supply line 6, which leads to a lighting unit 7 arranged on the rod part 420, departs from the adapter 5.

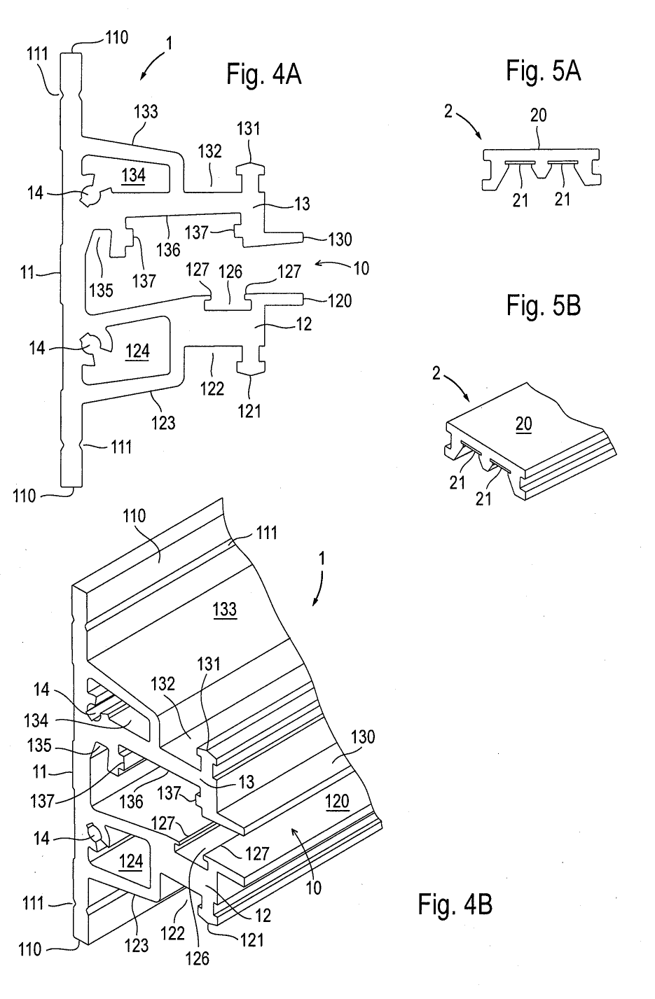

FIGS. 4A and 4B

At the profile rail 1, the end of the passage 10 is defined by a base 11 that extends with an extension 110 upward and downward, beyond the area of the incoming passage 10. The passage 10 is delimited by a top bar 13 and a bottom bar 12. Adjoining the base 11 and moving toward the exit of the passage 10, a hook groove 135 and a top groove 136 extend first along the profile rail 1 in the top bar 13. Near the opening, a bottom groove 126 runs likewise along the profile rail 1 in the bottom bar 12. The bottom groove 126 is bordered by retaining contours 127 and the top groove 136 by retaining contours 137 that serve for the later fastening of the profile strip 3 and the electrical profile 2. Opposite the base 11 and at the opening of the passage 10, the bottom bar 12 and the top bar 13 end with a lower lip 120 and an upper lip 130, respectively. Set back from the lips 120,130, a downward pointing strip 121 departs from the bottom bar 12 and an upward pointing strip 131 departs from the top bar 13, running parallel to the base 11 in the direction of the respective extensions 110.

A downwardly open external groove 122 is situated adjacent to the lower strip 121. An upwardly open external groove 132 is situated adjacent to the upper strip 131. A lower support bar 123 extends from the lower external groove 122 and an upper support bar 133 extends from the upper external groove 132. Both support bars 123,133 meet the base 11 obliquely so that a lower and an upper cavity 124,134 are enclosed between the bottom bar 12 and lower support bar 123 and between the top bar 13 and upper support bar 133, respectively. A screw channel 14 is situated adjacent to the base 11, inside the respective cavity 124,134. Notch lines 111, which run lengthwise along the profile rail 1 and serve as an aid when fitting, are present on the base 11, on one side facing the opening of the passage 10 and on the other side opposite the latter, on the rear. The profile rail 1 is preferably produced as an extruded aluminum profile.

FIGS. 5A and 5B

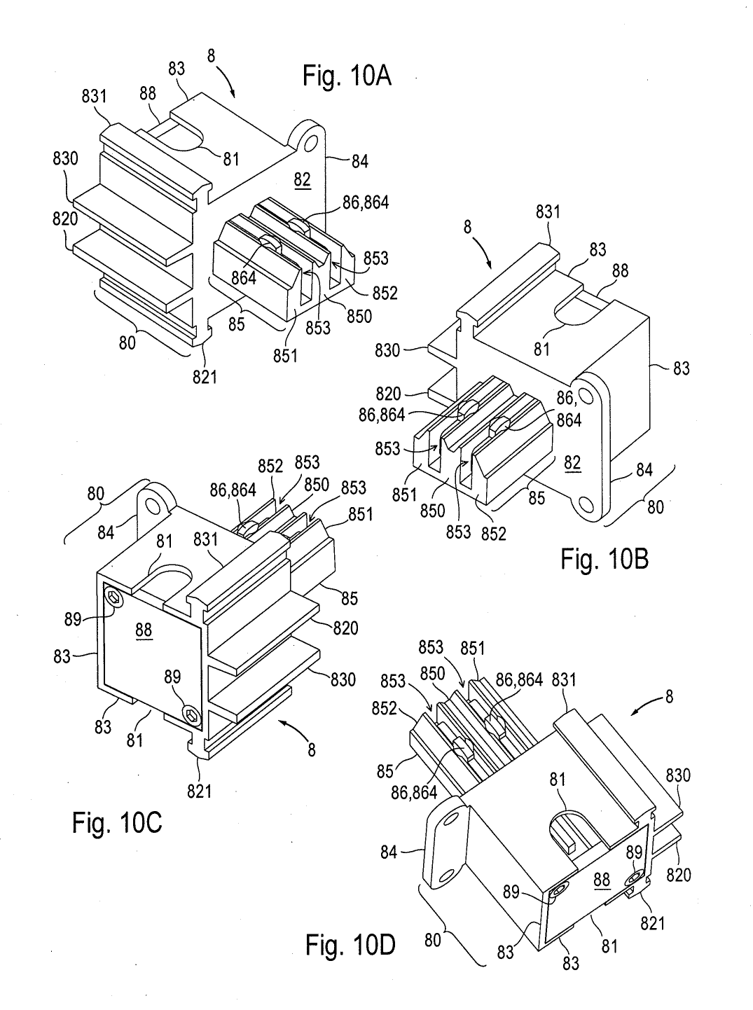

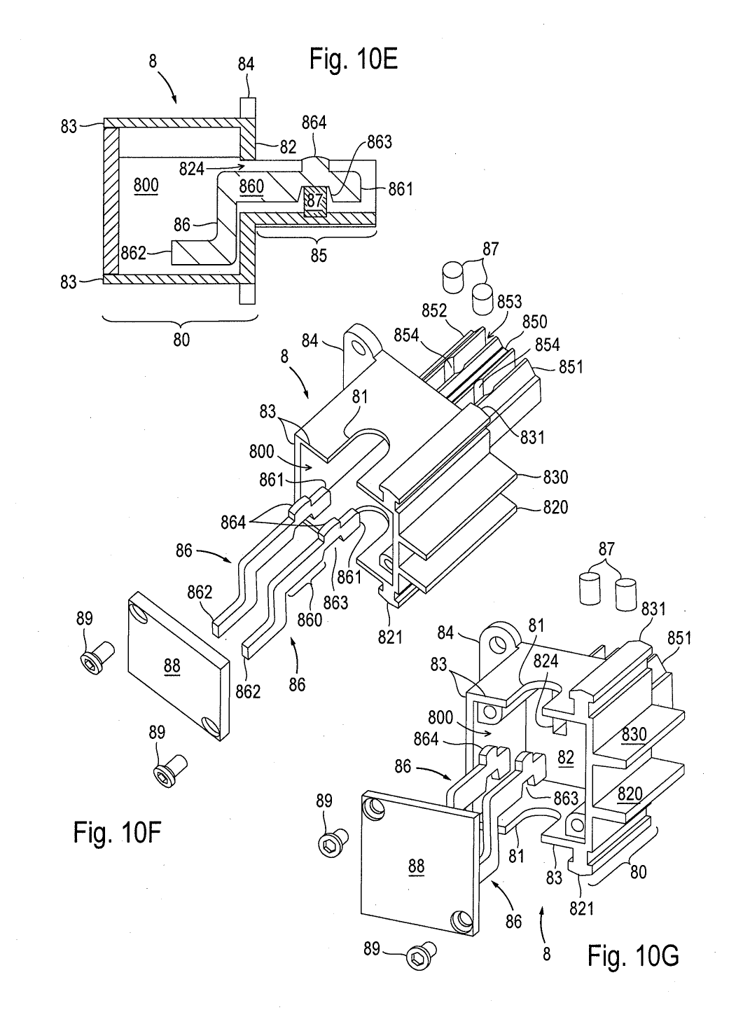

The electrical profile 2 with an insulation 20 in which two spaced-apart electrical conductors 21 are embedded has the form of an elongated flat band that has longitudinal contours. On one side, the contours complement the design of the top groove 136 and serve for the tight fit of the electrical profile 2 in the top groove 136. On the other side, the contours of the electrical profile 2 complement the design of the protrusions 850-852 on the extension 85 of the power feed unit 8 (see FIG. 10A).

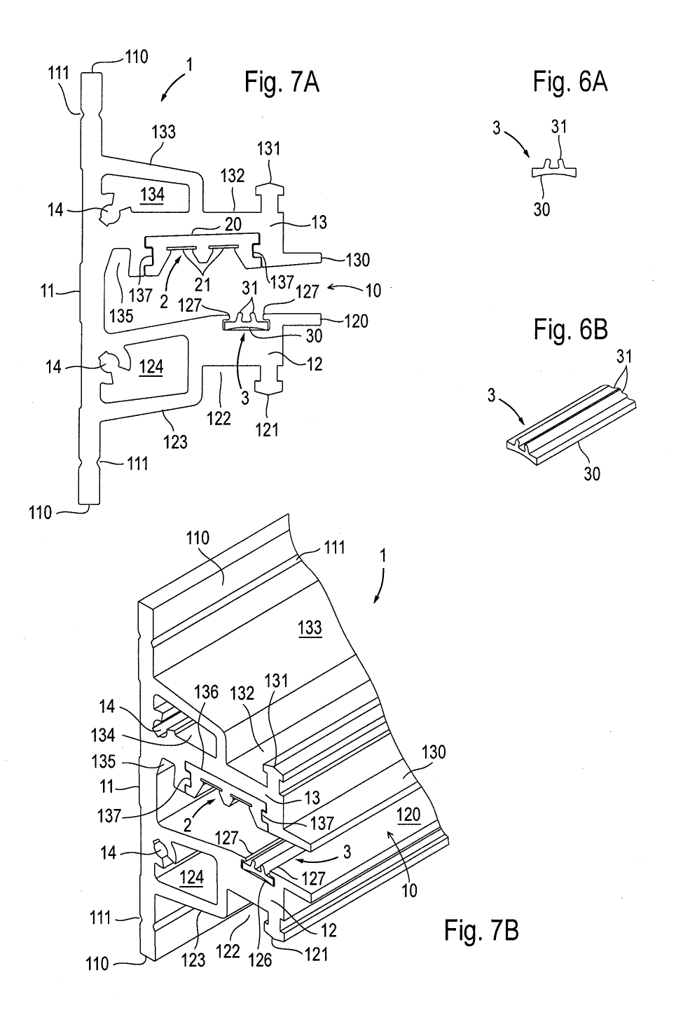

FIGS. 6A and 6B

A profile strip 3 that can be inserted into the bottom groove 126 and is made from an elongated, preferably elastic material serves to prevent a primary support 4 inserted into the profile rail 1, in particular in the form of a tray 41, from slipping. The profile strip 3 has a base 30 from which two protrusions 31 directed toward each other extend upward.

FIGS. 7A and 7B

When completed, the electrical profile 2 is inserted in the top groove 136 of the profile rail 1 and the profile strip 3 in the bottom groove 126 of the profile rail 1.

The insulation 20 of the electrical profile 2 with the contours on it is fixed in place by the complementary retaining contours 137 of the profile rail 1. The electrical conductors 21 can be accessed over the entire axial extent in an at least largely uninterrupted fashion from the passage 10 for tapping electricity via the adapter 5, in order to supply it via the supply line 6 to an attached consumer, for example in the form of a lighting unit 7. The base layer 30 of the profile strip 3 is held clamped in the bottom groove 126. The protrusions 31 project slightly above the top edge of the retaining contours 127, thus extend a little into the passage 10, and provide a non-slip and damping effect for primary supports 4, such as trays 41 and support arms 42, inserted into the passage 10.

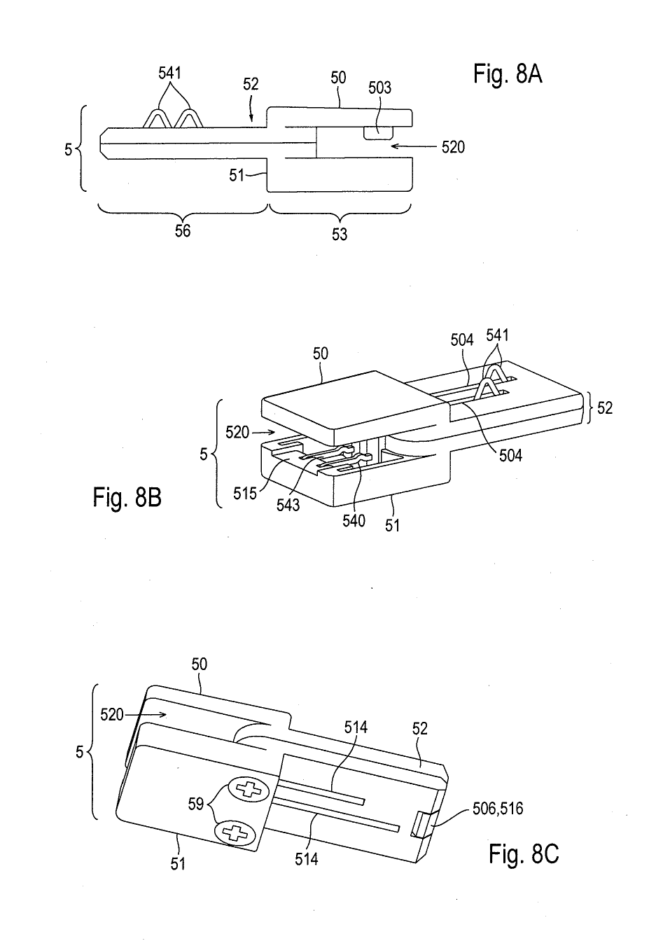

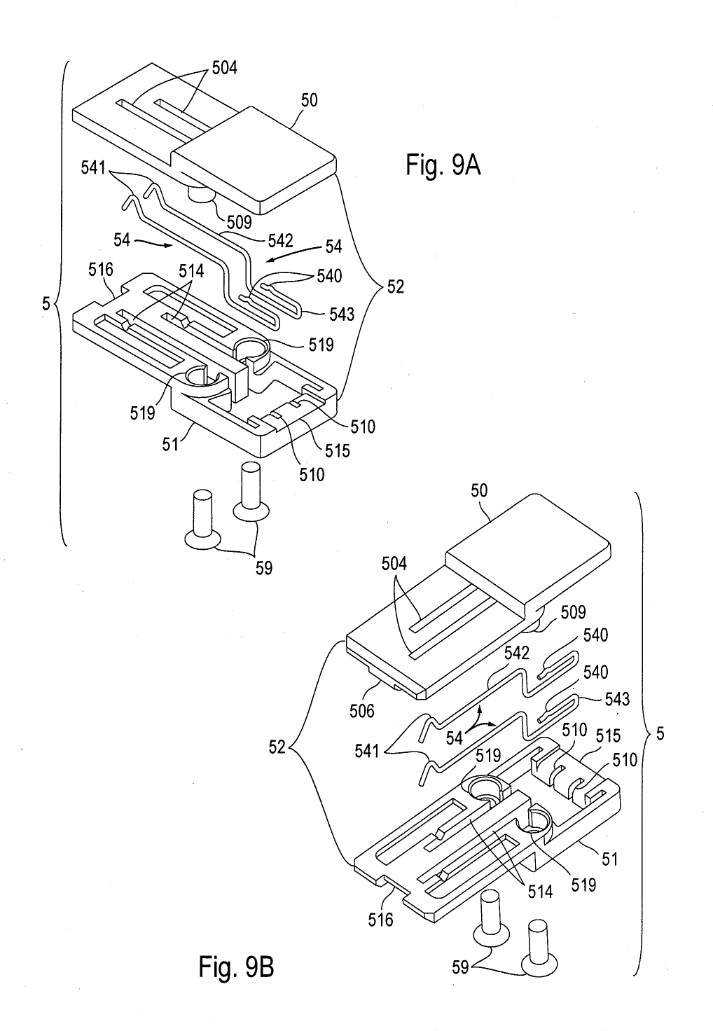

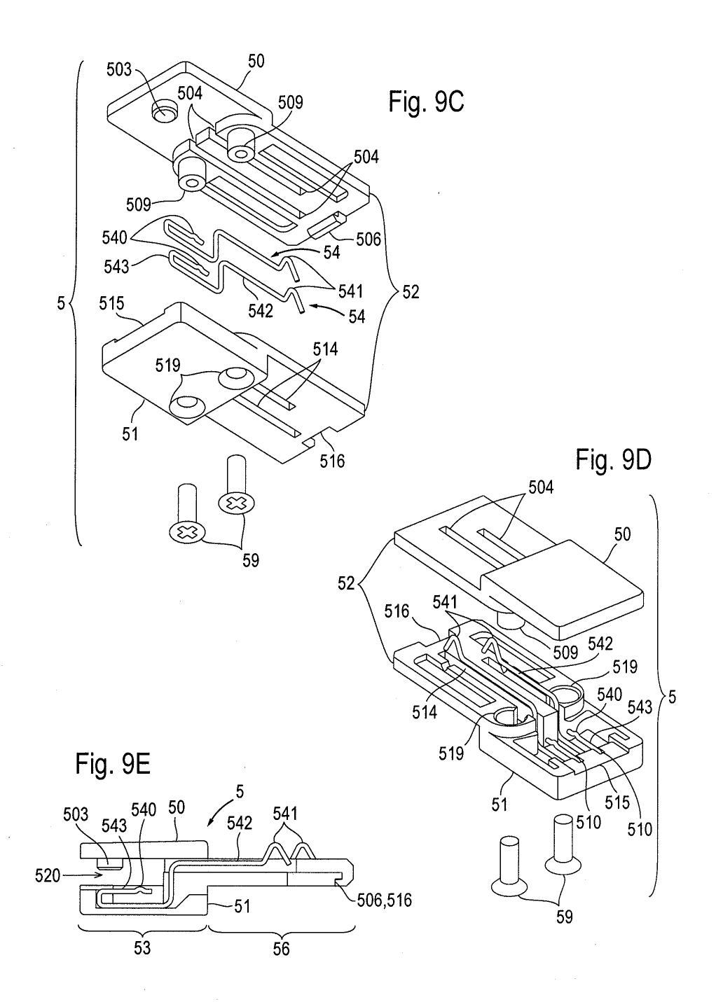

FIGS. 8A to 9E

The adapter 5 is in the shape of a rectangular block with a front section 56 and a thicker rear part 53 connected thereto and is composed of a top part 50 and a complementary bottom part 51 which form the housing 52. The top part 50 and bottom part 51 leave an opening 520 open on three sides in the rear part 53. On the top side of the top part 50, the current collectors 54 arranged in the housing 52 project with their contacts 541 through two parallel recesses 504 of different lengths that perforate the top part 50. The current collectors 54 are received and guided in the recesses 504. Corresponding with the recesses 504 in the top part 50, the bottom part 51 likewise has two parallel recesses 514 of different lengths that perforate the bottom part 50 and the purpose of which is to receive and guide the current collectors 54.

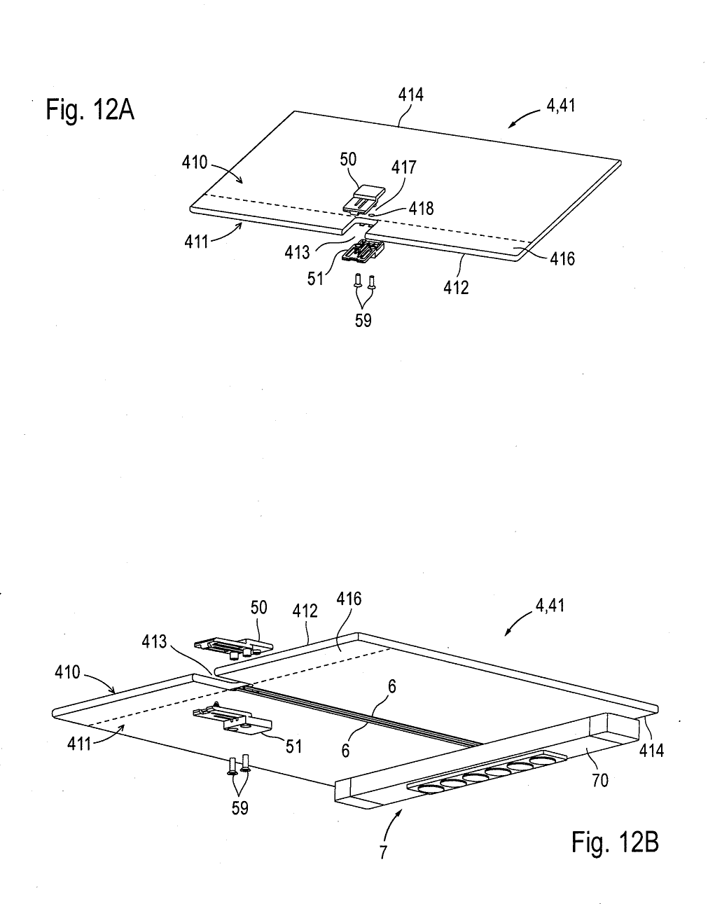

The top part 50 has a first locking element 506 in the form of a hook on the narrow side of the front section 56. A first complementary contour 516 interacting with the first locking element 506 and in the form of a notch is situated on the narrow side of the front section 56 on the bottom part 51 in order to form an interlocking connection. On the underside at the transition point from the rear part 53 to the front section 56, the top part 50 has second pin-like locking elements 509 with an internal thread. These second locking elements 509 are designed to interact positively with second complementary contours 519 in the form of holes that are open on the top side of the bottom part 51 and open on the underside for the introduction of screws 59. When fitted, the screws 59 engage in the internal thread in the second locking elements 509. A pin 503, which serves for engagement in a hole in the connection region 417 in the tray 41, extends from the underside of the top part 50 at the rear part 53 into the opening 520 (see FIG. 12A).

A relieved portion 515 with two groove-shaped indentations 510 that are spaced apart and are aligned with the recesses 514 is provided in the bottom part 51 at the narrow side of the rear part 53. The respective indentation 510 is open in the direction of the recess 514 and the top part 50 in order to house therein in each case the terminal region 543 of a current collector 54. The individual current collector 54 is in principle an angled wire bent several times and having a resilient bending extent 542 that on one side adjoins the contact 541 that is shaped like the “and” logic symbol A and forms the free end, and on the other side merges into a U-shaped terminal region 543 at which a connector 540 is present and represents the opposite free end of the current collector 54. The bending extents 542 of the current collectors 54 are housed so that they can move elastically vertically in the recesses 504 on the top part 50 and the recesses 541 on the bottom part 51. The contacts 541 project out of the recesses 504 in the top part 50, and the connectors 540 fit into a free space on the bottom part 51.

FIGS. 10A to 10G

The power feed unit 8 has a cuboid housing 80 with a front face 82 from which a profile piece 85 extends axially. The housing 80 is enclosed by four side walls that end at a circumferential edge 83, creating a cavity 800. A first lip 820 and a second lip 830 spaced apart from and parallel to it run along a side face over the length of the housing 80 oriented toward the profile piece 85. An axially extending first strip 821 extends in the corner region of this side face and the adjoining bottom face. An axially extending second strip 831 extends in the corner region of the side face in question and the adjoining top face. A flange 84 in which two boreholes are present extends within the plane of the end face 82 from the latter, opposite the lips 820,830. The profile piece 85 consists of a straight first protrusion 851, a straight second protrusion 852, and a central segment 850, a groove 853 lying between each of the protrusions 851,852 and the central segment 850. A widened portion 854 is provided in each groove 853, transverse to the longitudinal direction.

Two perforations 824 which lie in the direction in which the grooves 853 extend are present in the end face 82. An electrical connector 86 projects through each individual perforation 824, a central part 860 present on it coming to lie in the corresponding groove 853. The central part 860 has a receptacle 863 facing the bottom of the groove 853 and which serves as a seating for a spring 87. A contact face 864 stands proud of the central part 860, opposite the receptacle 863. Adjoining the central part 860, the electrical connector 86 ends in a first end 861. After the perforation 824, facing the cavity 800, the central part 860 deviates in the manner of a step and ends in the second end 862. The second end 862 of the respective electrical connector 86 is connected to the electrical cable. The cavity 800 can be closed by a cover 88 and can be fixed by means of screws 89 projecting through the cover 88 to boreholes present in stops in the cavity 800. The outer face of the cover 88 ends flush with the circumferential edge 83 of the housing 80. A recess 81 that serves for the passage of the cable is in the top face of the housing 80.

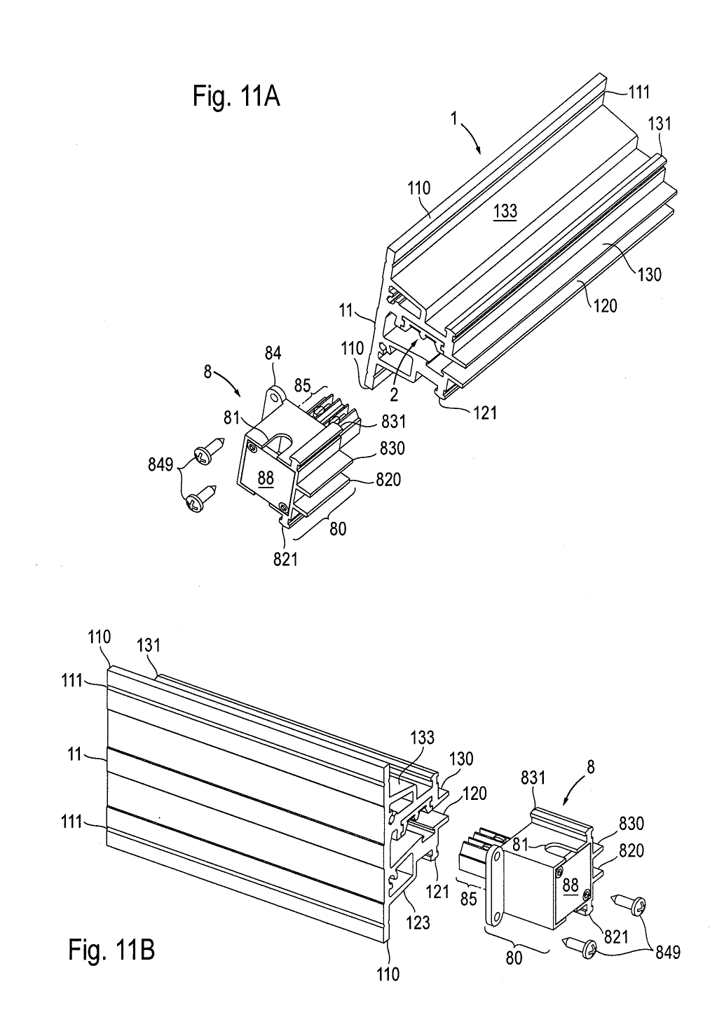

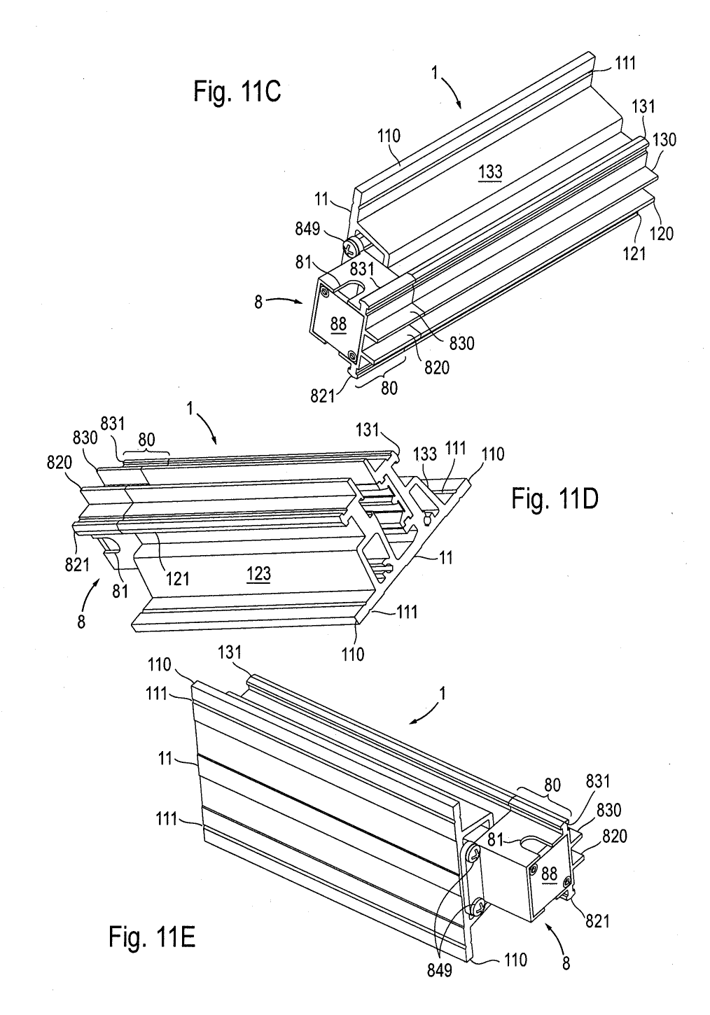

FIGS. 11A to 11E

The power feed unit 8 is first brought close axially to the profile piece 85 of the profile rail 1, the first strip 821 present on the housing 80 being aligned with the associated lower strip 121 on the bottom bar 12, and the second strip 831 on the housing 80 runs in the same direction as the upper strip 131 positioned on the top bar 13. The first lip 820 situated on the housing 80 is aligned with the lower lip 120 of the bottom bar 12, and the second lip 830 on the housing 80 is aligned with the upper lip 130 of the top bar 13. The two electrical connectors 86 embedded in the grooves 853 of the profile piece 85 are aligned with the electrical conductors 21 of the electrical profile 2. The boreholes present in the flange 84 are aligned with the corresponding screw channel 14 in the cavities 124,134 of the profile rail 1.

When the power feed unit 8 is connected to the profile rail 1, the screws 849 project through the boreholes in the flange 84 and engage in the respective screw channel 14 of the cavities 124,134. The profile piece 85 docked to the power feed unit 8 thus engages with its central segment 850, the first protrusion 851, and the second protrusion 852 in complementary fashion with the longitudinal contours on the electrical profile 2, adjacent to the electrical conductors 21. The contact faces 864 of the electrical connectors 86 bear against the electrical conductors 21 of the electrical profile 2, and the springs 87 that are thus slightly pretensioned ensure a reliable, permanent electrical bridging. To do this, the central part 860 of the respective electrical connector 86 is designed to be slightly resilient. The end face 82 of the power feed unit 8 bears against the cross sectional surface of the free end of the profile rail 1.

FIGS. 12A and 12B

The rear edge 412 of the primary support 4 in the form of a tray 41 has a cutout 413 within the insertion section 416, the cutout 413 being designed to receive the two housing parts 50,51 of the adapter 5. Adjacent to the cutout 413, a hole 418 is present in the connection region 417 of the tray 41 and serves to receive the pin 503 on the top part 50, as a result of which the adapter 5 is additionally fastened to the tray 41 when the housing 50 is assembled. A supply line 6 advantageously extends from the relieved portion 515 of the bottom part 51 of the adapter 5, along the underside 411 of the tray 41, to the lighting unit 7. The lighting unit 7 with the housing 70 be attached to the top side 410 and/or the underside 411 and/or the front edge 414 and/or the side faces of the tray 41 as a point light source or a linear luminaire. As long as the retaining device 70 that serves to fasten the lighting unit 7 extends as far as the adapter 5, the supply line 6 can be accommodated in the retaining device 70. This retaining device 70 could then simultaneously be used to remove heat, which is beneficial when LEDs are used in the lighting unit 7 and the tray 41 is applied in, for example, the cosmetics industry.

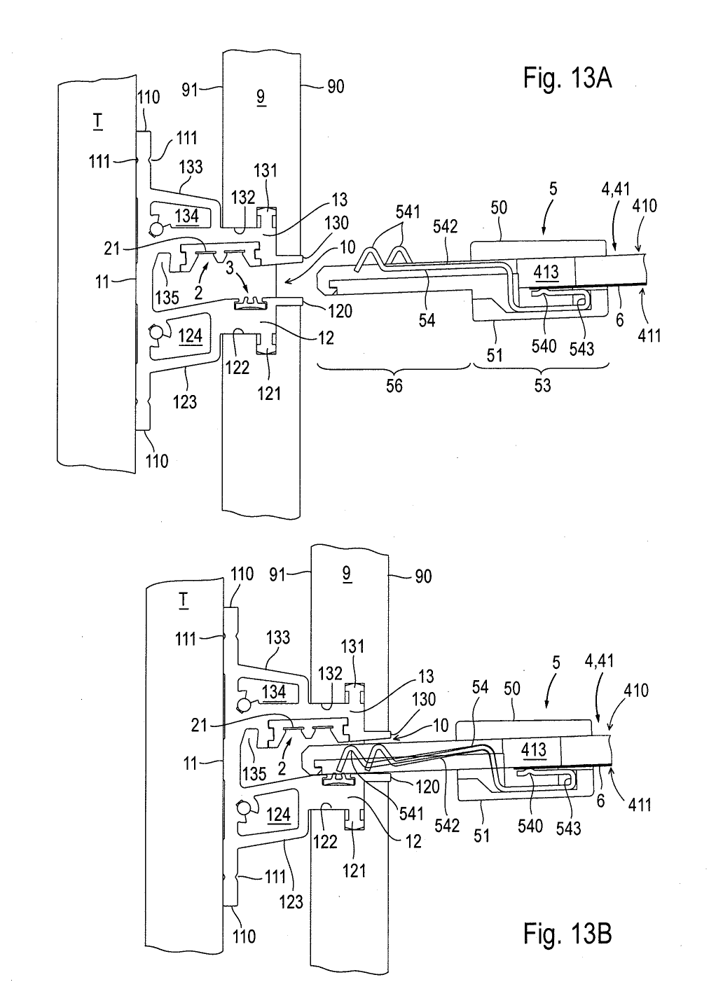

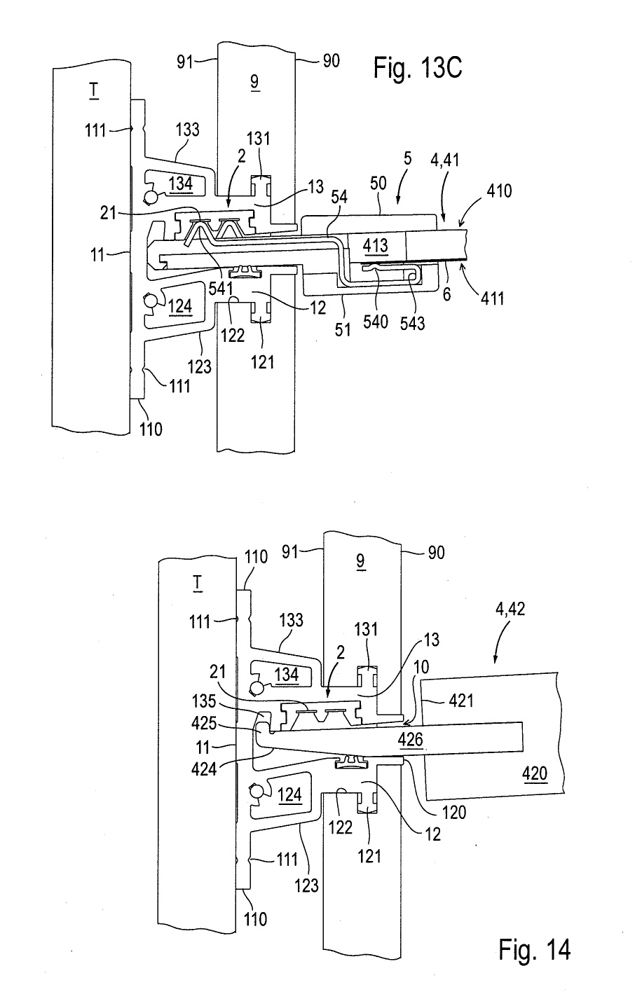

FIGS. 13A to 13C

The procedure for inserting a primary support 4 in the form of a tray 41 into a profile rail 1 mounted on the support structure T and clad with panel elements 9.

FIG. 13A (Initial Stage).

The horizontally oriented tray 41 is brought close to the opening of the passage 10 of the profile rail 1, with its insertion section 416 at the front and the adapter 5 mounted therein, so that the rear edge 412 of the tray 41 is situated in front of and aligned with the passage 10. The free end of the front section 56 of the adapter 5 is directed toward the opening of the passage 10. The contacts 541 of the current collectors 54 that are situated in the unloaded rest position project from the housing 52.

FIG. 13B (Intermediate Stage)

When the insertion section 416 of the tray 41 and hence also the front section 56 of the adapter 5 are pushed into the passage 10 of the profile rail 1, the mutually offset contacts 541 of the two current collectors 54 one after the other strike the upper lip 130 of the top bar 13 and, because they are sloping, are depressed into the recesses 504,514 of the adapter housing 52.

FIG. 13C (Final Stage)

When the insertion section 416 of the tray 41 and the front section 56 of the adapter 5 has been pushed as far as it will go into the passage 10 of the profile rail 1—the rear edge 412 of the tray hereby abuts the inside of the base 11—the contacts 541 of the current collectors 54 move upward owing to its spring tensioning and are presses against the electrical conductors 21 such that electricity is tapped. The top part 50 of the adapter 5 and the top side 410 of the insertion section 416 of the tray 41 are situated adjacent to the top bar 13, the bottom part 51 of the adapter 5 and the underside 411 of the insertion section 416 of the tray 41 being positioned opposite the bottom bar 12.

When the tray 41 is pulled out of the passage 10, the contacts 541 of the two current collectors 54 of the adapter 5 one after the other strike sloping contours on the electrical profile 2 and, because the contacts 541 are sloping, are pushed back into the recesses 504,514 in the adapter housing 52. The taping of electricity is thus interrupted. The tray 41 with the adapter 5 can be pulled—in the opposite direction to the direction in which it was previously pushed in—out of the passage 10 into the room.

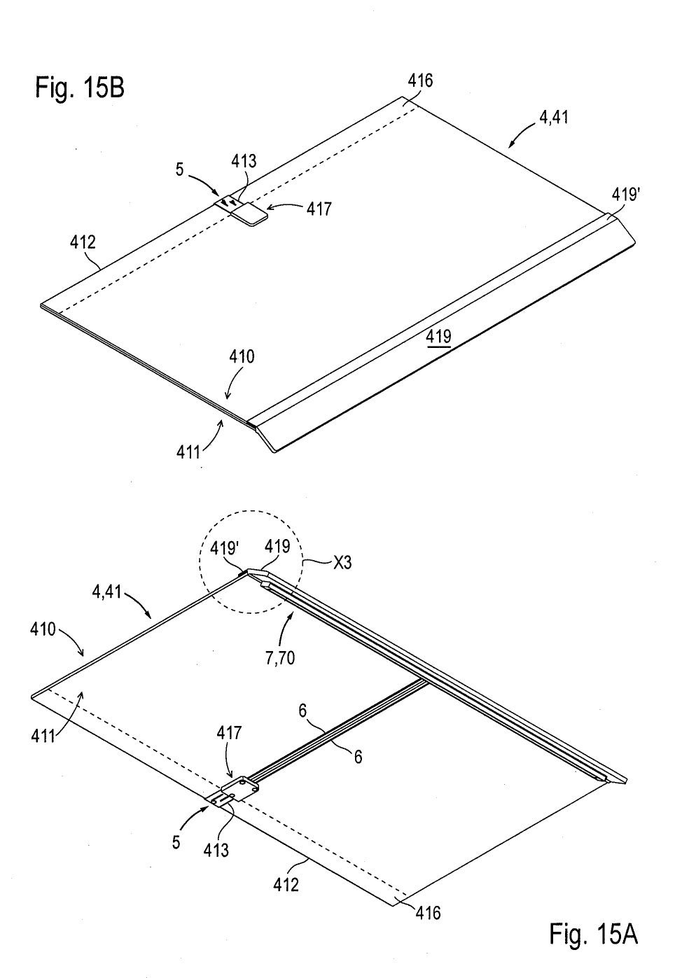

FIG. 14

When a non-electrified support arm 42 has been inserted, the hook 425 starting from the insertion section 426 comes to lie in the hook groove 135. It is by design impossible for the electrical profile 2 embedded in the top groove 136 to come into contact with the insertion section 426 in any position. The first end 421 of the bar part 420 of the support arm 42 is situated a short distance in front of the lower lip 120 of the bottom bar 12 and in front of the upper lip 130 of the cover bar 13 so that the support arm 42 can be mounted and unhooked.

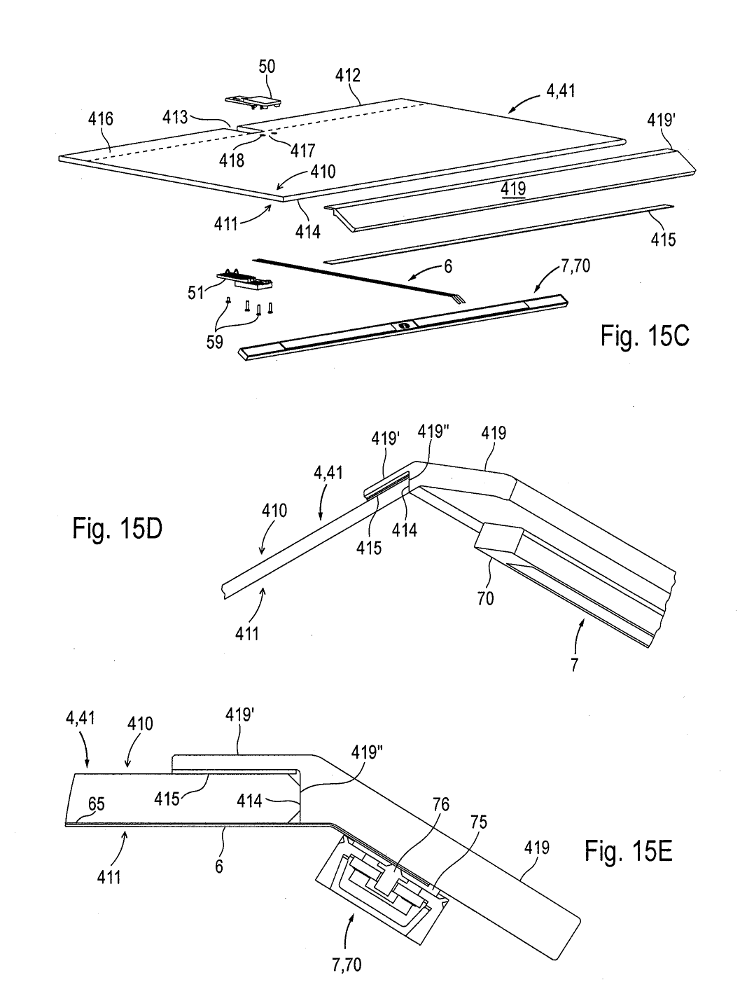

FIGS. 15A to 15E

The tray 41 has an add-on section 419 with a lip 419′ opposite the insertion section 412. The lip 419′ lies on the top side 410 of the tray 41 and is supported with an inner edge almost along the front edge 414 of the tray 41. An adhesive strip 415 that fixes the add-on section 419 in place on the tray 41 is interposed between the lip 419′ and the top side 410 of the tray 41. The front edge 414 of the tray 41 and the lip edge 419″ of the add-on section 419 hereby abut each other. In this combined state, the add-on section 419 extends downward from the tray 41 at an angle. The lighting unit 7 with the retaining device 70 is positioned on the underside of the add-on section 419 by means of an adhesive strip 75. The supply line 6 runs between the adapter 5 and the lighting unit 7 on the underside 411 of the tray 41 and on the underside of the add-on section 419. A contact 76 spring-mounted in the retaining device 70 is connected on the lighting unit 7 to the supply line 6 and enables the lighting unit 7 to be supplied with electricity. The supply line 6 is fixed in place on the underside 411 of the tray 41 and on the underside of the add-on section 419 by means of an adhesive strip 65.

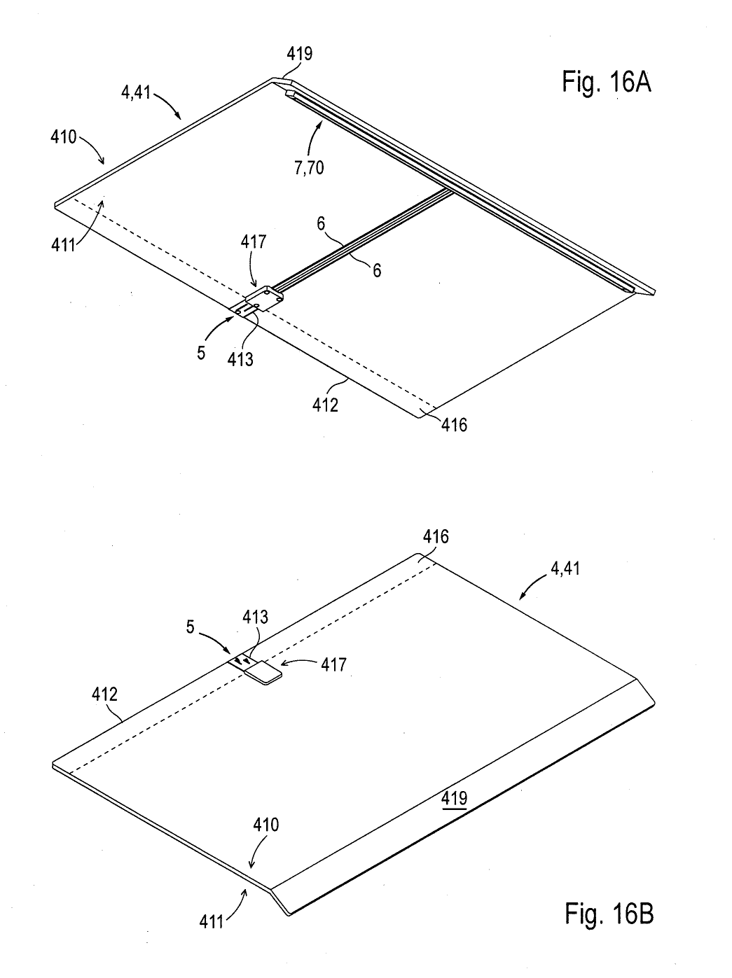

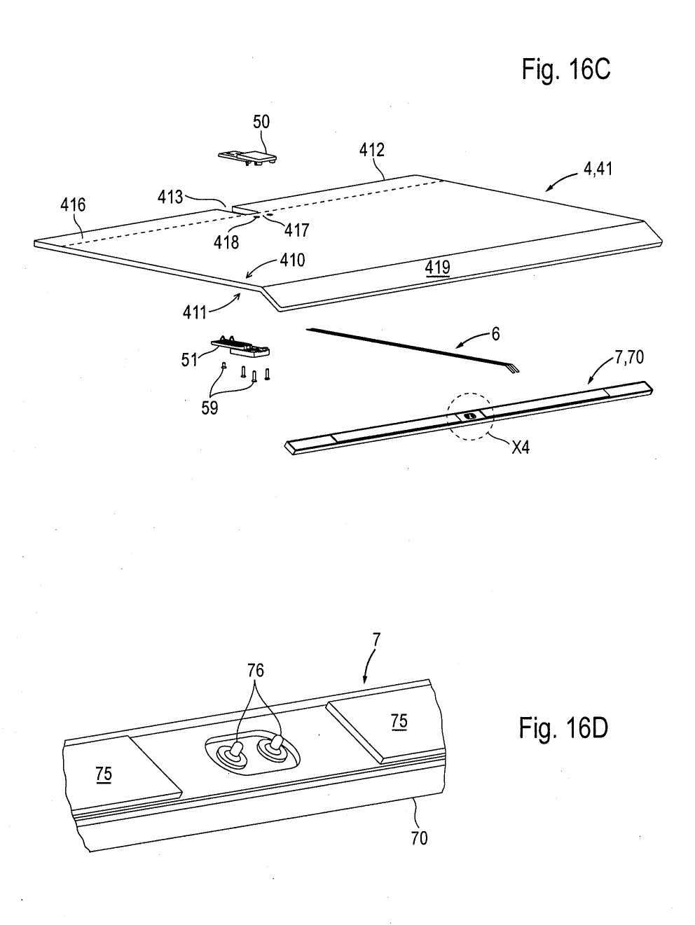

FIGS. 16A to 16D

In contrast to the series of drawings above, the downwardly angled add-on section 419 here extends integrally from the tray 41. The tray 41 and the add-on section 419 are preferably made from the same material, for example aluminum. The adhesive strip 75 is interrupted in the region of the contacts 76 that serve to tap electricity on the supply line 6 so that the tapping can be effected unimpeded.

1. A suspension device for presenting goods with:
a) a profile rail (1) into which an electrical profile (2) is inserted through which extend electrical conductors (21) that are partially embedded in insulation (20) and can be accessed via a passage (10) of the profile rail (1) that opens to the outside;
b) a primary support (4) that can be hung in the profile rail (1) and has an insertion section (416,426) that can be pushed into the passage (10); wherein
c) an adapter (5), that is designed to take off current at the electrical conductors (21) to operate a lighting unit (7) is arranged on the insertion section (416) of the primary support (4);
d) an electrical supply line (6) extends from the adapter (5) to the lighting unit (7); and
e) the adapter (5) has a housing (52) and current collectors (54) with contacts (541) that are designed to take off current at the electrical conductors (21), characterized in that
f) the spring-loaded contacts (541) protrude from the housing (52) and can be pushed back into the housing (52) when the insertion section (416) is pushed into the passage (10), and, when the insertion section (416) has been pushed completely into the passage (10) and positioned congruently with the electrical conductors (21), the contacts (541) are pressed against the electrical conductors (21) by the spring force.

2. The suspension device as claimed in claim 1, characterized in that the spring loading of the current collectors (54) is based on its inherent elasticity with a degree of bending travel (542).

3. The suspension device as claimed in either claim 1 or 2, characterized in that
a) the adapter (5) has a rear part (53) and a front section (56) designed to be inserted into the passage (10) of the profile rail (1) and in which the contacts (541) are arranged;
b) the adapter (5) has two current collectors (54) that are each formed from a wire mounted so that it can move elastically in the housing (52);
c) the contact (541) of a current collector (54) is situated at its front free end and is formed from a hook that tapers upwards and is, for example, V-shaped or U-shaped;
d) the bending section (542) extends from the contact (541) as far as a terminal region (543) that represents the rear end of the current collector (54);
e) a connector (540) is present at the terminal region (543) that leads to the electrical supply line (6); and
f) the housing (52) has recesses (504,514) inside which the current collectors (54) are received in such a way that they can move vertically elastically.

4. The suspension device as claimed in one of claims 1 to 3, characterized in that
a) the housing (52) consists of a bottom part (51) and a top part (50);
b) an indentation (510) that opens in the direction of the recesses (514) and the top part (50) is in each case present in the rear part (53) of the bottom part (51) and is flush with the recesses (514) that extend lengthwise so that the terminal region (543) of a current collector (54) can be housed therein;
c) mutually complementary first locking members (506,516) and second locking members (509,519) are provided in the top part (50) and the bottom part (51) in order to connect the two together, at least one pair of the locking members (509, 519) that engage with each other additionally being secured by means of screws (59);
d) when the housing (52) is assembled, the adapter (5) has, in its rear part (53) adjacent to the inserted terminal regions (543) of the current collectors (54), an opening (520) that opens to the outside for connection to the primary support (4); and
e) the bottom part (51) has a relieved portion (515), that widens the opening (520) and serves to lead the supply line (6) to the connectors (540) of the current collectors (54).

5. The suspension device as claimed in one of claims 1 to 4, characterized in that
a) a connection region (417) of the primary support (4) in the form of a tray (41) is fixed in the opening (520) of the adapter (5);
b) the tray (41) has the insertion section (416) that is designed to be pushed with its rear edge (412) at the front into the outwardly open passage (10) of the profile rail (1); and
c) a cutout (413) is provided in the insertion section (416), is open at the rear edge (412), adjoins the connection region (417), and inside which the front section (56) of the adapter (5) is arranged.

6. The suspension device as claimed in one of claims 1 to 5, characterized in that
a) the tray (41) has a top side (410), an underside (411), and a front edge (414) that faces the room; and
b) the lighting unit (7) is preferably arranged on the top side (410) and/or underside (411) and/or front edge (414).

7. The suspension device as claimed in one of claims 1 to 5, characterized in that
a) the tray (41) has a top side (410), an underside (411), and a front edge (414) that faces the room;
b) an attached downwardly inclined add-on section (419) extending from the front edge (414);
c) the lighting unit (7) is preferably arranged on the underside of the add-on section (419); and
d) the tray (41) and the add-on section (419) can be made from different materials.

8. The suspension device as claimed in one of claims 1 to 5, characterized in that
a) the tray (41) merges, with respect to the insertion section (416), integrally into a downwardly inclined add-on section (419);
b) the lighting unit (7) is preferably arranged on the underside of the add-on section (419); and
c) the tray (41) and the add-on section (419) can be made from the same material.

9. The suspension device as claimed in one of claims 1 to 8, characterized in that the profile rail (1) has:
a) a bottom bar (12) adjoining the passage (10) on one side and inside which, facing the entrance into the passage (10), a bottom groove (126) is situated for receiving a profile strip (3) to prevent slipping and as a damping element for the inserted primary support (4);
b) a top bar (13) adjoining the passage (10) on the other side and inside which are situated:
ba) facing the entrance into the passage (10), a top groove (136) for receiving the electrical profile (2); and
bb) in the rear region of the passage (10), a hook groove (135) that serves for the engagement of a complementary hook (425) on the insertion section (426) of the primary support (4) in the form of a support arm (42); and
c) a flat base (11) into which the bottom bar (12) and the top bar (13) open and which defines the end of the passage (10).

10. The suspension device as claimed in claim 9, characterized in that the profile rail (1) also has:
a) a support bar (123) that extends from the bottom bar (12) at an angle toward the base (11);
b) a support bar (133) that extends from the top bar (13) at an angle toward the base (11);
c) retaining contours (127) on the bottom groove (126) and retaining contours (137) on the top groove (136) for fixing the inserted profile strip (3) and the inserted electrical profile (2);
d) a lip (120) as a continuation of the bottom bar (12) and a lip (130) as a continuation of the top bar (13) to form the entrance into the passage (10);
e) a rail (121) that starts from the bottom bar (12) and has an adjoining external groove (122) and a rail (131) that starts from the top bar (13) and has an adjoining external groove (132), which are used to add panel elements (9) by their longitudinal edges (92) in an interlocking fashion;
f) in each case an extension (110) that extends downward and upward flush from the base (11) and projects beyond the respective support bar (123, 133) that is open there;
g) a lower cavity (124) that is formed between the bottom bar (12), the lower support bar (123), and the base (11);
h) an upper cavity (134) that is formed between the top bar (13), the upper support bar (133), and the base (11); and
i) in each case an axially extending screw channel (14) that adjoins the cavities (124,134).

11. The suspension device as claimed in one of claims 1 to 10, characterized in that a power feed unit (8) is provided that has:
a) a housing (80) with an end face (82) from which a profile piece (85) extends;
b) electrical connectors (86) that lie embedded in grooves (853) present on the profile piece (85) and each have a contact face (864);
c) a spring (87) beneath each electrical connector (86) in the associated groove (853);
d) contours (850-852) on the profile piece (85) that are designed to engage in a complementary fashion with the electrical profile (2) inserted in the profile rail (1) and the contours present thereon; and
e) a cavity (800) in which the connectors (86) are received and which is continued by a cable leading to the power source; wherein
f) when the power feed unit (8) is connected to the profile rail (1), the contact faces (864) of the connectors (86) bear against the electrical conductors (21) of the electrical profile (2) and the springs (87) that are thus slightly tensioned ensure that current is tapped securely and permanently.

12. The suspension device as claimed in one of claims 1 to 11, characterized in that
a) the electrical conductors (21) preferably conduct low voltage; and
b) the lighting unit (7) is fitted with LEDs.

13. The suspension device as claimed in one of claims 1 to 4 and 9 to 12, characterized in that the primary support (4) has the form of a support arm (42) and has:
a) the insertion section (426) facing the profile rail (1);
b) a rod part (420) that projects into the room and the first end (421) of which is connected to the insertion section (426) and which has a free second end (422);
c) a cutout in the insertion section (426) that is open toward the free end of the insertion section (426) and is designed for the insertion of the adapter (5); and
d) a lighting unit (7) arranged on the rod part (420).
